(19) United States
(12) Patent Application Publication
(10) Pub. No.: US 2005/0122905 A1
(43) Pub. Date: Jun. 9, 2005

(54) Method of providing packet data service

(75) Inventor: Ji A. Jung, Anyang-si (KR)

Correspondence Address: FLESHNER & KIM, LLP, P.O. BOX 221200, CHANTILLY, VA, 20153, US

(73) Assignee: LG Electronics Inc.

(21) Appl. No.: 10/944,750

(22) Filed: Sep. 21, 2004

(30) Foreign Application Priority Data
Dec. 4, 2003 (KR) KR 87665/2003

(51) Int. Cl. H04L 12/26

(52) U.S. Cl. 370/230

(57) ABSTRACT

A method of providing a packet data service includes assigning a unique identifier to each access terminal (AT) in an access network. In accordance with one embodiment, this is accomplished by assigning a terminal identifier to a mobile terminal, receiving a request message for a session connection from the mobile terminal, deciding presence or non-presence of a validity of the request message for the session connection, and transferring a connection deny message or allocating a traffic channel according to a result of the deciding step.

### BACKGROUND OF THE INVENTION

1. Field of the Invention

The present invention generally relates to communication systems, and more particularly to a system and method for providing packet data communications.

2. Background of the Related Art

In high-rate packet data (HRPD) communications, if power of an access terminal is turned on, an access network assigns an access terminal identifier to the access terminal. A unicast access terminal identifier (UATI) is one example of such a terminal identifier.

Once a session is set up, an access network identifies an identity of each access terminal using a unicast access terminal identifier. And, the access network or a packet control function (PCF) unit interoperates with an AN-AAA (access network authentication, authorization, and accounting) unit to perform an authentication process. The corresponding access terminal then enables to acquire a unique and permanent MN-ID (mobile node identification).

After the authentication, authorization, and accounting process, the MN-ID is used in billing a service. The packet control function unit maps the valid unicast access terminal identifier (UATI) to the mobile node identification (MN-ID) to transfer billing information and the like to a packet data serving node (PDSN) while the session of the access terminal is maintained.

However, the related art may bring about at least the following problems. First, even if the access network already closed the corresponding session, one access terminal (hereinafter called “first access terminal”) maintains the session information to retain the unicast access terminal identifier. A unicast access terminal identifier is a limited resource of the access network and the unicast access terminal identifier assigned to the access terminal may be released. As a result, the unicast access terminal identifier may be duplicated to be assigned to another access terminal (hereinafter called “second access terminal”) by the access network. Consequently, at least two different access terminals may retain the same unicast access terminal identifier.

Second, the access network is unable to identify the first and second access terminals which have the same unicast access terminal identifier. This may cause various problems. For instance, in case where the first access terminal receives a packet data service, a user of the second access terminal may be billed. Also, the first access terminal can receive the packet data service of which session has already been closed instead of the authorized second access terminal. Besides, the corresponding session may be closed regardless of the intention of the second access terminal. And, the first access terminal unnecessarily raises the signaling load on the access network.

### SUMMARY OF THE INVENTION

An object of the invention is to solve at least the above problems and/or disadvantages and to provide at least the advantages described hereinafter.

Another object of the present invention is to provide a system and method of providing a packet data service, in which an access network (AN) assigns a unique identifier to each access terminal (AT) in order to distinguish these terminals from each other in packet data communications.

To achieve these and other objects and advantages, the present invention provides a packet data service which uses a terminal identifier in a communication system which includes a network and at least one mobile terminal. In such a packet data service, a method according to the present invention includes the steps of assigning the terminal identifier to the mobile terminal, receiving a request message for a session connection from the mobile terminal, deciding presence or non-presence of a validity of the request message for the session connection, and transferring a connection deny message or allocating a traffic channel according to a result of the deciding step. Preferably, the request message for the session connection includes the terminal identifier and the timestamp therein.

According to another embodiment, the present invention provides a packet data service which uses a terminal identifier in a communication system that includes a network and at least one mobile terminal. In this packet data service, a method is performed which includes the steps of transferring a session close message from the mobile terminal to the network, deciding presence or non-presence of a validity of the session close message, and maintaining or releasing session information according to a result of the deciding step.

According to another embodiment of the present invention, a packet data service providing method includes the steps of requesting a terminal identifier assignment to the network, receiving the terminal identifier and a timestamp from the network, transferring a connection request message including the terminal identifier and the timestamp to the network, having a connection deny message or a traffic channel allocated hereto according to a validity test result from the network, and releasing session information if the terminal receives the connection deny message.

Accordingly to another embodiment of the present invention, a packet data service providing method includes the steps of transferring a first session close message including the terminal identifier and a timestamp to the network, receiving a second session close message according to a validity test result of the first session close message in the network, and closing a session information if the second session close message is received.

According to another embodiment of the present invention, a packet data service providing method includes the steps of requesting a terminal identifier assignment to the network, transferring the terminal identifier and a timestamp to the mobile terminal, transferring a connection request message including the terminal identifier and the timestamp to the network, checking a validity of a corresponding connection request in the network, and transferring a connection deny message or allocating a traffic channel according to a result of the checking.

The foregoing embodiments are advantageous in that when the access network (AN) assigns an identifier for terminal identification to each access terminal (AT), the present invention may assign a unique identifier to securely provide a service to a valid terminal only in the packet data communications. While this advantage may prove useful for a variety of application, the embodiments of the invention may be implemented to achieve other advantages depending, for example, on the intended application.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

FIG. 1 is a block diagram of a system which implements an interoperability specification (IOS) for performing high rate packet data (HRPD) communications.

FIG. 2 is a flowchart showing steps included in one type of process of assigning a unicast access terminal identifier (UATI) to an access terminal (AT) from an access network (AN).

FIG. 3 is a flowchart of a process of setting up a connection between an AT and an AN.

FIG. 4 is a flowchart of a session connecting process by an AT according to one embodiment of the present invention.

FIG. 5 is a flowchart of a session closing process between an AT and an AN.

FIG. 6 is a flowchart of a session closing process in case of invalid access terminal according to one embodiment of the present invention.

FIG. 7 is a flowchart of a session closing process in case of valid access terminal according to one embodiment of the present invention.

### DETAILED DESCRIPTION OF PREFERRED EMBODIMENTS

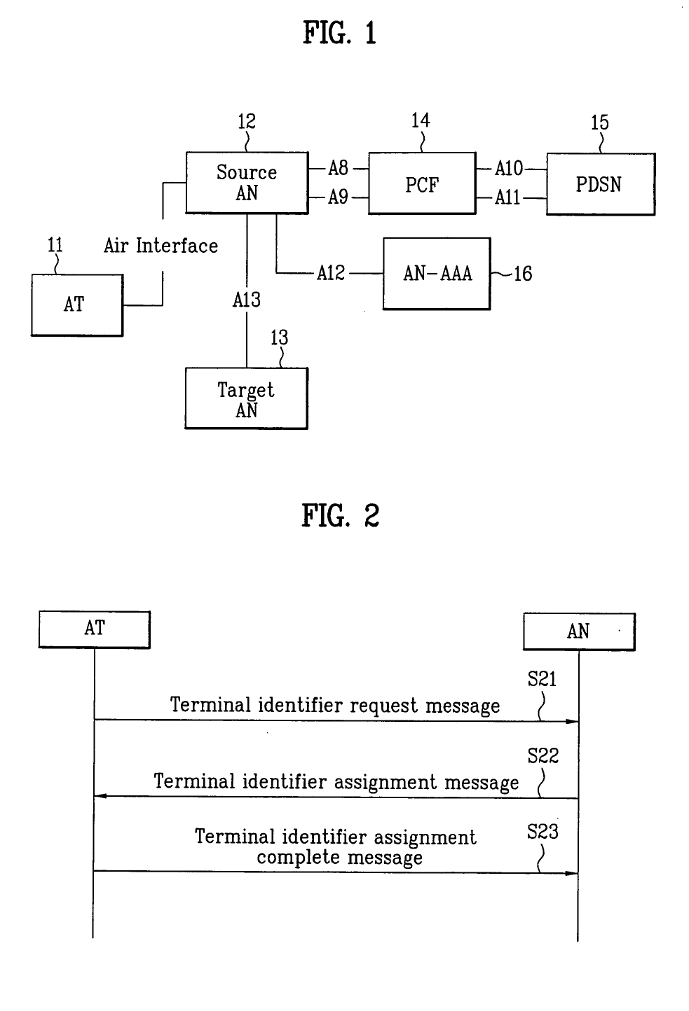

FIG. 1 is a block diagram of a system which implements an interoperability specification (IOS) for performing high rate packet data (HRPD) communications. The system includes an access terminal (AT) 11, a source access network 12, a target access network 13, a packet control function (PCF) unit 14, a packet data serving node (PDSN) 15, and an access network authentication/authorization/accounting (AN-AAA) unit 16.

FIG. 2 is a flowchart showing steps included in one type of process of assigning a unicast access terminal identifier (UATI) to an AT from an AN. If power of an AT is turned on, the AT transfers a UATI request (UATIRequest) message to an AN (S21). The AN transfers a UATI assignment (UATIassignment) message to the AT (S22). The AT having received the UATI assignment message transfers a UATI assignment complete (UATIcomplete) message to the AN (S23).

TABLE 1

| Field | Length (bit) |
|---|---|
| MessageID | 8 |
| TransactionID | 8 |

Table 1 shows one structure of the UATI request (UATIRequest) message. IN addition to all or a portion of these fields the present invention includes a time identifier (TimeStamp) field having a specific length in the UATI request message. The time identifier field can have a 32-bits length.

TABLE 2

| Field | Length (bit) |
|---|---|
| MessageID | 8 |
| MessageSequence | 8 |
| Reserved1 | 7 |
| SubnetIncluded | 1 |
| UATISubnetMask | 0 or 8 |
| UATI024 | 0 or 104 |
| UATIColorCode | 8 |
| UATI024 | 24 |
| UpperOldUATILength | 4 |
| Reserved2 | 4 |

Table 2 shows a structure of the UATI assignment (UATIAssignment) message.

TABLE 3

| Field | Length (bit) |
|---|---|
| MessageID | 8 |
| MessageSequence | 8 |
| Reserved | 4 |
| UpperOldUATILength | 4 |
| UpperOldUATI | 8 * UpperOldUATILength |

Table 3 shows one structure of a UATI assignment complete (UATIComplete) message. The message structures shown in Tables 1 to 3 follow the 3GPP2 (3^{rd} generation Project Partnership 2) standard.

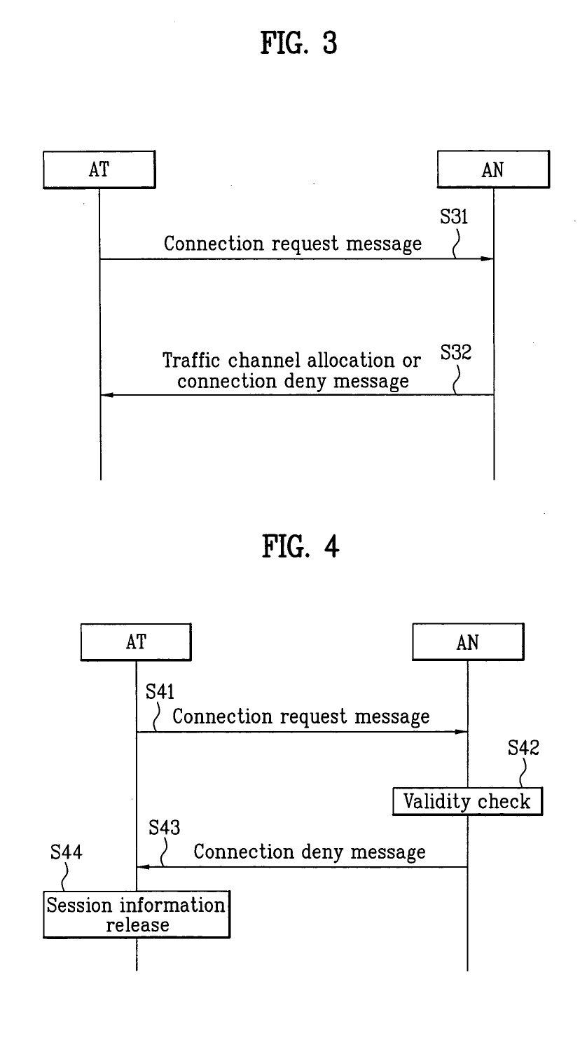

FIG. 3 is a flowchart showing steps included in another process of setting up a connection between an AT and an AN. In this process, an AT transfers a connection request (ConnectionRequest) message to an AN to receive a high rate packet data (HRPD) service (S31). The AN then allocates a traffic channel to the AT or transfers a connection deny (ConnectionDeny) message to the AT (S32).

TABLE 4

| Field | Length (bit) |
|---|---|
| MessageID | 8 |
| TransactionID | 8 |
| RequestReason | 4 |
| Reserved | 4 |

Table 4 shows a structure of a connection request (ConnectionRequest) message which maybe used in the above process.

TABLE 5

| Field | Length (bit) |
|---|---|
| MessageID | 8 |
| TransactionID | 8 |
| RequestReason | 4 |
| Reserved | 4 |

Table 5 shows a structure of a connection deny (ConnectionDeny) message which maybe used in the above process.

TABLE 6

| Field | Representation |
|---|---|
| 0x0 | General |
| 0x1 | Network Busy |
| 0x2 | Authentication or billing failure |

All other values reserved

Table 6 shows a structure of a deny reason (DenyReason) field included in a connection deny (ConnectionDeny) message in the above process. The message structures disclosed in Tables 4 to 6 follow the 3GPP2 (3^{rd} generation project partnership 2) standard as the third generation mobile communications standard.

FIG. 4 is a flowchart showing steps included in a session connecting process performed by an AT according to one embodiment of the present invention. In this process, an AT preferentially transfers a connection request (ConnectionRequest) message to an AN to perform a session connection (S41). After having performed a validity test on the connection request message (S42), the AN allocates a traffic channel to the AT or transfers a connection deny (ConnectionDeny) message to the AT (S43). The AT having received the connection deny message closes session information (S44).

In the validity test of the AN, a time identifier (timestamp) included in the UATI can be used. More specifically, if the AT includes the time identifier in the connection request (ConnectionRequest) message and then transfers it to the AN, the AN compares the received time identifier to its stored time identifier to decide the presence or non-presence of validity of the AT (S42). In case of transferring the connection deny (ConnectionDeny) message, the AN enables to include a deny reason (DenyReason) field of ‘unsuitable session’ in the connection deny message to transmit (S43).

TABLE 7

| Field | Length (bit) |
|---|---|
| MessageID | 8 |
| CloseReason | 8 |
| MoreInfoLen | 8 |
| MoreInfo | 8 * MoreInfoLen |

Table 7 shows one structure of a session close (SessionClose) message. The message structure disclosed in Table 7 follows the 3GPP2 (3^{rd} generation project partnership 2) standard as the third generation mobile communications standard.

As mentioned in the foregoing description, FIG. 2 is a flowchart of a process of assigning a unicast access terminal identifier (UATI) to an AT from an AN. If the AN having received the UATI connection request (ConnectionRequest) message from the AT allocates a traffic channel, the AN, as shown in FIG. 2, transfers a UATI assignment (UATIAsignment) message to the AT. In doing so, a time identifier (TimeStamp) field is included in the connection request message. Preferably, the time identifier (TimeStamp) filed may have a 32-bits length.

TABLE 8

| Field | Length (bit) |
|---|---|
| MessageID | 8 |
| MessageSequence | 8 |
| Reserved1 | 7 |
| SubnetIncluded | 1 |
| UATISubnetMask | 0 or 8 |
| UATI024 | 0 or 104 |
| UATIColorCode | 8 |
| UATI024 | 24 |
| UpperOldUATILength | 4 |
| Reserved2 | 4 |
| TimeStamp | 32 |

Table 8 shows a structure of a UATI assignment (UATIAssignment) message according to one embodiment of the present invention. The message structure disclosed in Table 8 follows the 3GPP2 (3^{rd} generation project partnership 2) standard as the third generation mobile communications standard.

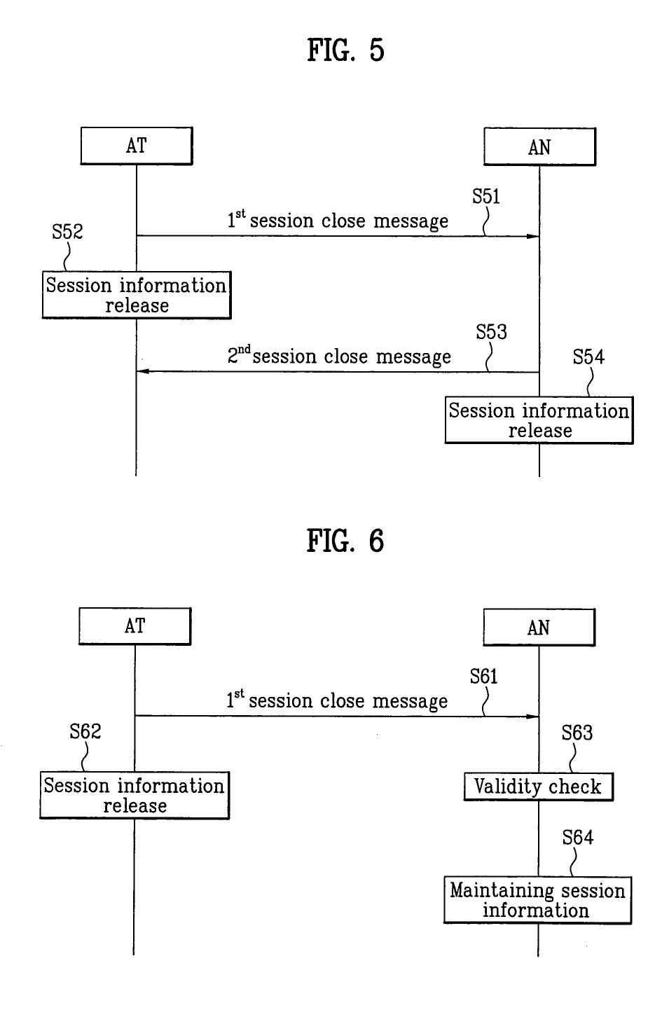

FIG. 5 is a flowchart of a session closing process between AT and AN. In this session close method, an AT transfers a first session close message for a session close to an AN (S51) and the AT closes its session information (S52). Meanwhile, the AN transfers a second session close message to the AT (S53) and session information of the AT existing on the AN (S54).

FIG. 6 is a flowchart of a session closing process in case of invalid access terminal according to an embodiment of the present invention. In order to close a session, an AT transfers a first session close (SessionClose) message to an AN (S61) and closes its session information (S62). A MoreInfoLen field of the session close message may include a time identifier (TimeStamp) value and a MoreInfo field may include a time identifier (TimeStamp) value having been received from the AN.

The AN receives the first session close message and then checks whether the received first session close message is valid (S63). Namely, the AN decides whether the time identifier (TimeStamp) value within the message coincides with the time identifier value retained by the AN via comparison. If the AT is decided as ‘invalid’ as a result of the comparison, the AN maintains the session information (S64) to make a session state coincide with a valid AT. Namely, in order to prevent the session information of the valid AT from being closed, the AN does not transfer a second session close (SessionClose) message as a response to the received session close (SessionClose) message.

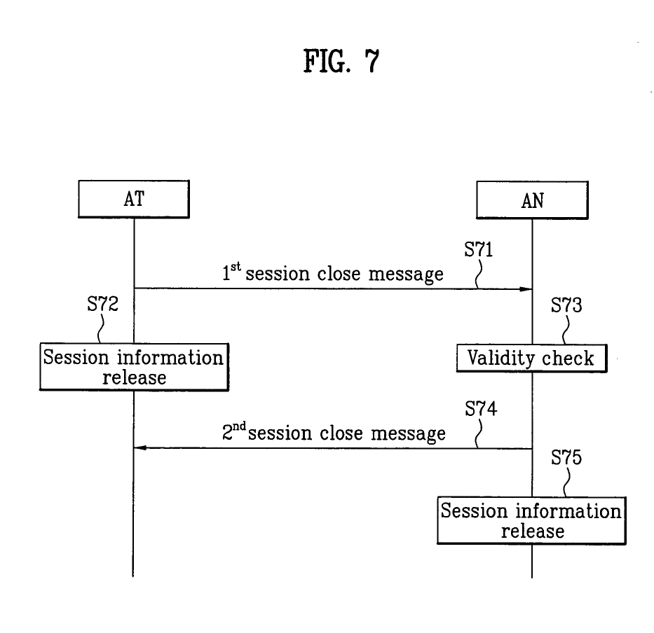

FIG. 7 is a flowchart of a session closing process in case of valid access terminal according to the present invention. Referring to FIG. 7, in order to close a session, an AT transfers a first session close (SessionClose) message to an AN (S71) and closes its session information (S72). A MoreInfoLen field of the session close message may include a time identifier (TimeStamp) value and a MoreInfo field may include a time identifier (TimeStamp) value having been received from the AN.

The AN receives the first session close message and then checks whether the received first session close message is valid (S73). Namely, the AN decides whether the time identifier (TimeStamp) value within the message coincides with the time identifier value retained by the AN via comparison. If the AT is decided as ‘valid’ as a result of the comparison, the AN transfers a second session close (SessionClose) message to the AT (S74) and closes the session information for the AT (S75).

Accordingly, when the access network (AN) assigns an identifier for terminal identification to each access terminal (AT), the present invention assigns a unique identifier to securely provide a service to a valid terminal only in the packet data communications.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

1. A method for providing a packet data service, comprising:
receiving a request message for a session connection from a mobile terminal;
deciding presence or non-presence of a validity of the request message for the session connection; and
transferring a connection deny message or allocating a traffic channel according to a result of the deciding step.

2. The method of claim 1, wherein the connection deny message is transferred when non-presence of the validity is decided.

3. The method of claim 1, further comprising:
assigning a terminal identifier to a mobile terminal, said assigning including:
receiving a terminal identifier request message;
generating a timestamp; and
transferring the timestamp to the mobile terminal.

4. The method of claim 3, further comprising:
receiving a terminal identifier assignment complete message.

5. The method of claim 3, wherein the request message for the session connection includes the terminal identifier and the timestamp therein.

6. The method of claim 5, wherein the timestamp includes a system time of the network at a time point of assigning the user identifier.

7. The method of claim 1, wherein in the deciding step, an access network compares a stored timestamp to a timestamp included in the request message to decide the presence of the validity if the stored timestamp is identical to the timestamp included in the request message.

8. The method of claim 1, wherein the connection deny message includes a DenyReason field indicating ‘unsuitable session’.

9. The method of claim 1, wherein the network and the mobile terminal are an access network and an access terminal, respectively.

10. A method for providing a packet data service, comprising:
transferring a session close message from a mobile terminal to a network;
deciding presence or non-presence of a validity of the session close message; and
maintaining or releasing session information according to a result of the deciding step.

11. The method of claim 10, wherein the transferred session close message includes a terminal identifier and a timestamp therein.

12. The method of claim 11, the deciding step comprises:
comparing a timestamp stored in the network to the timestamp included in the session close message; and
deciding the presence of the validity if the stored timestamp is identical to the timestamp included in the session close message.

13. The packet data service providing method of claim 10, wherein if the session close message is valid as a result of the deciding step, a session is closed.

14. The method of claim 13, further comprising:
transferring the session close message to the mobile terminal.

15. The method of claim 10, wherein the network and the mobile terminal are an access network and an access terminal, respectively.

16. A method for providing a packet data service, comprising:
requesting a terminal identifier assignment to a network;
receiving the terminal identifier and a timestamp from the network;
transferring a connection request message including the terminal identifier and the timestamp to the network;
allocating a connection deny message or a traffic channel according to a validity test result from the network; and
releasing session information if the terminal receives the connection deny message.

17. The method of claim 16, wherein the timestamp is a system time of the network at a time point of assigning the user identifier.

18. A method for providing a packet data service, comprising:
transferring a first session close message including a terminal identifier and a timestamp to a network;
receiving a second session close message according to a validity test result of the first session close message in the network; and
closing a session information if the second session close message is received.

19. The method of claim 18, wherein the validity test result is decided by:
comparing a timestamp stored in the network to the timestamp included in the first session close message: and
deciding a presence of validity if the stored timestamp is identical to the timestamp included in the first session close message.

20. A method for providing a packet data service, comprising:
requesting a terminal identifier assignment to a network;
transferring the terminal identifier and a timestamp to a mobile terminal;
transferring a connection request message including the terminal identifier and the timestamp to the network;
checking a validity of a corresponding connection request in the network; and
transferring a connection deny message or allocating a traffic channel according to a result of the checking step.
